(19) United States
(12) Patent Application Publication
(10) Pub. No.: US 2016/0362195 A1
(43) Pub. Date: Dec. 15, 2016

(54) FUEL DELIVERY SYSTEM AND METHOD FOR TRANSFERRING FUEL USING COMPRESSED AIR TO FORCE FUEL FROM A TANK TO A REFUELED ITEM

(71) Applicants: Michael Joseph Wilkinson, Warrington, PA (US); David C. Taylor, Darby, MT (US)

(72) Inventors: Michael Joseph Wilkinson, Warrington, PA (US); David C. Taylor, Darby, MT (US)

(21) Appl. No.: 15/183,302

(22) Filed: Jun. 15, 2016

Related U.S. Application Data
(60) Provisional application No. 62/175,458, filed on Jun. 15, 2015.

(51) Int. Cl. B64F 1/28; B67D 7/36; B60S 5/02; B67D 7/38; B67D 7/84; B67D 7/04; B67D 7/62

(52) U.S. Cl. CPC B64F 1/28; B67D 7/04; B67D 7/36; B67D 7/62; B67D 7/38; B67D 7/845; B60S 5/02

(57) ABSTRACT

A fuel delivery system for transferring fuel using pressurized air includes a vehicle having a fuel tank supported by the vehicle, the fuel tank including a volume of fuel and a volume of pressurized air. A compressor supported on the vehicle and in fluid communication with the fuel tank operates to maintain a pressure of the pressurized air by monitoring a pressure of the air within the tank using a pressure sensor. A fuel transfer hose in fluid communication with the interior of the tank transfers the fuel to an item to be refueled using only a force of the pressurized air acting on the fuel when a tank valve of the tank is in the open position.

### CROSS-REFERENCE TO RELATED APPLICATIONS

This application claims priority to U.S. Provisional Patent Application Ser. No. 62/175,458, filed Jun. 15, 2015, the entire disclosure of which is hereby incorporated herein by reference.

### FIELD OF INVENTION

The present disclosure relates to a fuel delivery system and a method of operating the same, and more particularly to a pressurized gas fuel delivery system and a method of refueling a gasoline engine aircraft using the pressurized gas fuel delivery system.

### BACKGROUND

Current aircraft Av-gas refueling trucks carry approximately 1000 gallons of a fuel such as gasoline or diesel used in refueling engine powered aircraft. To transfer fuel to the aircraft, known Av-gas trucks carry a pump, a drive shaft, and a power takeoff (PTO). Rotational motion of the drive shaft is transferred to the pump by means of the PTO. The PTO configuration may for example include a rotatable shaft driven by the driveshaft that is caused to engage a corresponding aperture formed in the pump.

During fuel transfer, the truck is “bonded” to the aircraft by a conducting element which provides electron flow between the truck and the aircraft to prevent an incidence of arcing (sparking) during transfer of the fuel, which could potentially lead to ignition of the fuel during the refueling process. A truck fuel hose nozzle is inserted into an aircraft fuel-receiving hatch of the corresponding aircraft. The truck fuel hose nozzle is typically a “dead-man” fuel nozzle. The dead-man fuel nozzle is configured to automatically stop a flow of the fuel if the operator releases the dead-man nozzle lever, thereby serving as a safety measure for preventing an incidence of overflow of the fuel during the refueling process. A fuel delivery meter is positioned in the fuel delivery path to identify a rate and quantity of fuel delivered.

The pump carried on known Av-gas trucks is operated using the engine driven PTO to draw fuel from the tank, with a fuel delivery flow rate controlled by the operator using the hand-held fuel nozzle. The pump operates continuously during the refueling process, and is expensive both to purchase and to subsequently maintain. Additionally, the configuration of the PTO used to couple the pump to the driveshaft undesirably requires that the pump be positioned relative to the driveshaft in a manner suitable for mechanically transferring motion therebetween, thereby limiting the potential positions for the pump to those positions capable of forming a mechanical connection with the driveshaft. A fuel delivery system capable of efficiently and inexpensively transferring fuel from a fuel tank to an item to be refueled while eliminating the pump and the PTO requirements is therefore desirable.

### SUMMARY

Concordant and consistent with the present invention, a fuel delivery system utilizing a pressurized gas to deliver fuel in the absence of the traditional pump and PTO assembly has surprisingly been discovered.

According to an embodiment of the invention, a fuel delivery system comprises a fuel tank, a compressor, and a controller. The fuel tank includes a fuel portion occupied by a volume of a fuel and a pressurized air portion occupied by a volume of pressurized air. The compressor is in fluid communication with the pressurized air portion of the fuel tank. The controller is configured to maintain a pressure of the pressurized air portion between a low pressure threshold value and a high pressure threshold value by selectively operating the compressor.

A method of operating the fuel delivery system is also disclosed. The method comprises the steps of: providing a compressor and a fuel tank having a fuel portion occupied by a volume of the fuel and a pressurized air portion occupied by a volume of pressurized air, the compressor fluidly coupled to the pressurized air portion of the fuel tank; selectively operating the compressor to maintain a minimum pressure of the pressurized air portion; and transferring the fuel of the fuel portion to an item to be refueled using only a force of the pressurized air portion acting on the fuel portion.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and is not intended to limit the scope of the present disclosure.

FIG. 1 is schematic sectional view of a fuel delivery system including a vehicle carrying a fuel tank according to an embodiment of the invention; and

FIG. 2 is a flow chart illustrating a method of operating the fuel delivery system illustrated in FIG. 1.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the present disclosure, application, or uses.

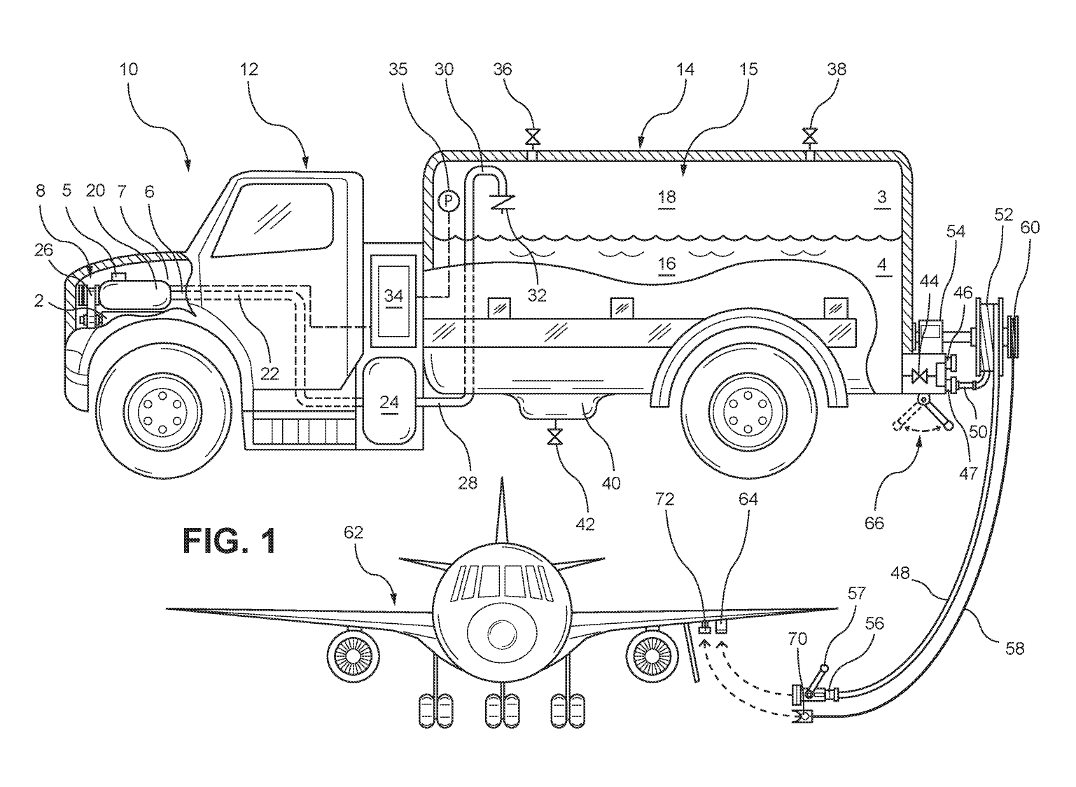

FIG. 1 shows a fuel delivery system 10 including a fuel delivery vehicle 12 supporting a fuel tank 14. The fuel delivery vehicle 12 may be any suitable vehicle for transporting a fluid such as any known fuel delivery truck. The fuel delivery vehicle 12 may alternatively be a cart or other structure suitable for transporting the tank 14. The tank 14 includes a hollow interior 15 for receiving and storing a volume of a fuel 16 and a volume of pressurized air 18. The fuel 16 may be any form of liquid fuel such as gasoline, diesel fuel, jet fuel, and derivatives thereof, as non-limiting examples. If the fuel delivery system 10 is used for an aviation related refueling application, the fuel 16 may be Av-Gas, for example. The pressurized air 18 has a lower volumetric density than the fuel 16. Hence, the volume of the pressurized air 18 is disposed above the volume of the fuel 16 with respect to a gravity direction. As shown in FIG. 1, the volume of the pressurized air 18 is disposed in a first portion 3 of the hollow interior 15 of the tank 14 and the volume of the fuel 16 is disposed in a second portion 4 of the hollow interior 15 of the tank 14. As should be understood, a change in a quantity or a density of either of the fuel 16 or the pressurized air 18 may result in a proportion of the hollow interior 15 of the tank 14 forming each of the first portion 3 and the second portion 4 to change such as during a pressurization process or a fuel transfer process associated with the tank 14.

The fuel delivery system 10 further includes a compressor 20 and a storage tank 24. The compressor 20 is configured to receive and compress air such as air supplied by the ambient environment. However, other sources for the air may be used without departing from the scope of the present invention. The compressor 20 may be any known compressor or similar device suitable for increasing the pressure of the incoming air to a level suitable for operation of the fuel delivery system 10. The compressor 20 may be a positive displacement compressor such as a reciprocating piston compressor, a rotary screw compressor, a rotary vane compressor, or a scroll compressor, for example. The compressor 20 may alternatively be a non-positive displacement compressor such as a centrifugal compressor, for example.

The compressor 20 may be disposed anywhere with respect to the vehicle 12, and, in an exemplary arrangement, can be positioned in an engine compartment 7 of the vehicle 12. The engine compartment 7 may be disposed adjacent a passenger compartment of the vehicle 12, for example. If disposed in the engine compartment 7, the compressor 20 may be operably engaged with a belt 26 disposed in the engine compartment 7 of the vehicle 12 via a clutch assembly 8. The belt 26 may be driven by an engine or motor 2 configured to also drive the vehicle 12. The engine or motor 2 may be an internal combustion engine, an electric motor, or a hybrid system, as non-limiting examples. The belt 26 may be engaged with the clutch assembly 8 for selectively transferring the translational motion of the belt 26 to a rotor of the compressor 20, thereby driving the internal components of the compressor 20 consistent with the type of compressor 20 selected. According to other embodiments, the compressor 20 can be electrically powered using DC electrical power generated by the vehicle 12 or generated by a battery or other energy source otherwise associated with the vehicle 12. The DC electrical power may subsequently be converted to the DC or AC voltage and/or amperage requirements of the compressor 20, as required. Additionally, although the mechanical connection between the engine or motor 2 and the compressor 20 is described as being formed by the belt 26, the clutch assembly 8, and the rotor of the compressor 20, it should be understood that the compressor 20 may be driven by the engine or motor 2 using any known mechanical connection suitable for transferring motion from the engine or motor 2 to the compressor 20, as desired, without departing from the scope of the present invention.

The compressor 20 includes an inlet side 5 and an outlet side 6. The inlet side 5 of the compressor 20 is configured to receive the stream of air from the ambient environment or any other suitable source for the stream of air. The inlet side 5 of the compressor 20 may accordingly be fluidly coupled to the ambient environment supplying the stream of air using any suitable conduits, ducting, or fluid flow paths extending through the vehicle 12, as desired. In some embodiments, the compressor 20 may receive at least a portion of the stream of air normally received into the vehicle 12 to circulate within a portion of a heating, ventilation, and air conditioning (HVAC) system of the vehicle 12. In other embodiments, the compressor 20 is directly fluidly coupled to the ambient environment to receive the stream of air therein.

Although pressurized air is identified herein as one representative compressible gas for providing the motive force to transfer a fuel, the present disclosure is not limited to pressurized air, as other compressible gasses can be used in systems that may transfer a fuel that is not compatible with pressurized air. However, in contrast to the use of air originating from the ambient environment, the use of an alternative compressible gas may require a separate gas storage device for storing the compressible gas in the absence of a continuous supply of the compressible gas.

The outlet side 6 of the compressor 20 is fluidly coupled to a storage tank 24 by a first pressure line 22. The first pressure line 22 may extend from the outlet side 6 of the compressor 20 to the storage tank 24 through any suitable path extending through or around the components of the vehicle 12. The first pressure line 22 may extend through an internal portion of the vehicle 12 including the engine compartment 7 or along an undercarriage or frame of the vehicle 12, as non-limiting examples. The storage tank 24 is configured to store the pressurized air supplied by the compressor 20. The storage tank 24 may be formed from any material suitable for withstanding the internal pressure caused by the introduction of the pressurized air. The storage tank 24 may be disposed anywhere on the vehicle 12, as desired. As shown in FIG. 1, the storage tank 24 may be disposed on a frame or undercarriage of the vehicle 12 between the compressor 20 and the tank 14. However, other positions of the storage tank 24 may be used without departing from the scope of the present invention.

The storage tank 24 is fluidly coupled to the first portion 3 of the tank 14 by a second pressure line 28. The second pressure line 28 is depicted in FIG. 1 as extending from the storage tank 24 and through an underside of the tank 14, through the second portion 4 of the hollow interior 15 of the tank 14, and into the first portion 3 of the hollow interior 15 of the tank 14. However, alternative arrangements of the second pressure line 28 may be used without departing from the scope of the present invention. The second pressure line 28 may include a goose-neck 30 formed at an end of the second pressure line 28 disposed within the hollow interior 15 of the tank 14. The goose-neck 30 is configured to prevent an incidence of back-flow of the fuel 16 into the second pressure line 28 and subsequently the storage tank 24. Accordingly, the goose-neck 30 is disposed above a desired or maximum fuel fill level of the tank 14 to avoid an incidence of the goose-neck being exposed directly to the fuel 16.

The end of the second pressure line 28 disposed within the tank 14 may further include a check valve 32. The check valve 32 is configured to allow for the air to flow through the check valve 32 in only one direction, thereby also acting to prevent the incidence of back-flow of the fuel 16 into the second pressure line 28. The check valve may be any form of check valve including a ball check valve, a diaphragm check valve, and a swing check valve, as non-limiting examples.

The tank 14 includes a first overpressure vent device 36 and a redundant second overpressure vent device 38. The first overpressure vent device 36 and the second overpressure vent device 38 are each disposed in the first portion 3 of the tank 14 to expose the first overpressure vent device 36 and the second overpressure vent device 38 to the volume of the pressurized air 18. The first overpressure vent device 36 and the second overpressure vent device 38 are configured to automatically open to release a quantity of the volume of the pressurized air 18 when a pressure of the volume of pressurized air 18 exceeds a predetermined venting pressure threshold value. The venting pressure threshold value may be 15 psi, for example. The first overpressure device 36 and the second overpressure device 38 may each be pressure relief valves or safety relief valves, for example.

The tank 14 further includes a drain valve 42 disposed in the second portion 4 of the tank 14 having the volume of the fuel 16. The drain valve 42 may be disposed within a water sump 40 forming a lowermost portion of the hollow interior 15 of the tank 14. The water sump 40 is configured to collect liquid water accumulated within the tank 14 to remove the liquid water from the volume of the fuel 16. The liquid water may originate as condensation formed within the tank 14 as a result of the introduction of the compressed air originating from the compressor 20. The drain valve 42 may be opened to drain the liquid water periodically such as daily. In some embodiments, the drain valve 42 is configured to drain the liquid water in response to a preselected quantity of the liquid water accumulating within the water sump 40. However, any form of drain valve 42 may be used without departing from the scope of the present invention.

The tank 14 is further equipped with an internal tank valve 44. The internal tank valve 44 is schematically depicted in FIG. 1 as fluidly coupling the second portion 4 of the tank 14 including the volume of the fuel 16 to each of a first fuel connection 46 and a second fuel connection 47. The first fuel connection 46 is configured for use when receiving the fuel 18 into the tank 14 and the second fuel connection 47 is configured for use when the fuel 18 is delivered out of the tank 14. The internal tank valve 44 may include a manually controlled member 66 adjustable between at least a first position and a second position. The manually controlled member 66 may be a rod, a wire, or the like connected to the internal tank valve 44 and extending outwardly from the tank 14 to allow the operator to change the position of the manually controlled member 66 between the first position and the second position. According to several aspects, a biasing member can be provided as a part of the manually controlled member 66 to return the internal tank valve 44 from the second position to the first position following an actuation of the manually controlled member 66 to the second position. When the manually controlled member 66 is in the first position, the internal tank valve 44 may be adjusted to act as a form of a one-way valve or check valve allowing only for the introduction of the fuel 16 into the hollow interior 15 of the tank 14 through the first fuel connection 46 while blocking flow out of the tank 14 through the second fuel connection 47. Accordingly, when in the first position, the first fuel connection 46 may be coupled to a corresponding fuel source for delivering the fuel into the hollow interior 15 of the tank 14. When the manual control member 66 is moved to the second position, the internal tank valve 44 is configured to allow for the flow of the fuel 18 out of the hollow interior 15 of the tank 14 through the second fuel connection 47. The biasing member of the manually controlled member 66 accordingly acts as a safety feature ensuring that the fuel 16 is not ejected from the tank 14 when the operator is not manually controlling a position of the manually controlled member 66.

Although FIG. 1 depicts the internal tank valve 44 as including each of the first fuel connection 46, the second fuel connection 47, and the manually controlled member 66, it should be understood that any system of valves and passageways capable of preventing the undesired flow of the fuel 16 into or out of the tank 14 while also allowing for a desired flow of the fuel into or out of the tank 14 during a fuel transfer operation may be used, as desired. For example, one passageway and one valve may be used to control flow into the tank 14 and a separate passageway and a separate valve may be used to control flow out of the tank 14. Furthermore, additional safety features including manually operated valve assemblies, passively operated valve assemblies, and valve assemblies that open and close only when engaged with other corresponding components used in the fuel transfer operation may be used without departing from the scope of the present invention.

A flexible fuel transfer hose 48 is connected to the internal tank valve 44 via a connecting line 50 such as a pressure hose. The fuel transfer hose 48 is normally stowed on a hose reel 52 carried on the vehicle 12. The hose reel 52 is depicted in FIG. 1 as extending from a rear surface of the tank 14, but the hose reel 52 may be disposed anywhere on the vehicle 12 or the tank 14, as desired. At least one fuel flow meter 54 can be provided at any position visible to an operator of the fuel transfer operation. Each of the at least one fuel flow meter 54 is configured to provide visual indication to the operator of conditions of the fuel transfer operation including but not limited to a rate of flow of the fuel into or out of the tank 14, a total amount of fuel delivered into or out of the tank 14, and a quantity of fuel present in the tank 14, for example.

A manually operated dead-man fuel nozzle 56 is provided at a distal end of the fuel transfer hose 48. The dead-man fuel nozzle 56 may include an actuating device 57 such as a crank, lever, or trigger that must be actuated from a first position to a second position to allow for the flow of the fuel through the dead-man fuel nozzle 56. However, other dead-man fuel nozzles having alternative or additional configurations and safety features may be used without departing from the scope of the present invention. A bonding connection 58 such as a braided wire is extendable from a bonding reel 60 also carried on the vehicle 12. The bonding connection 58 is continuously electrically connected to the vehicle 12 and may include a bonding attachment device 70 disposed at an end thereof for releasably connecting the bonding connection 58 to a portion of an item to be refueled 62 such as a lug 72 or projection extending from the item to be refueled 62. The item to be refueled 62 is depicted in FIG. 1 as an aircraft, but the fuel delivery system 10 may be used for refueling any vehicle, device, or storage compartment without departing from the scope of the present invention. The dead-man nozzle 56 is releasably received in a refueling port 64 disposed on the item to be refueled 62 while the bonding connection 58 is releasably connected to the item to be refueled 62 via a connection of the bonding attachment device 70 to the lug 72.

The fuel delivery system 10 further includes a controller 34. The controller 34 is depicted as being disposed on the vehicle 12 adjacent the tank 14 and the storage tank 24, but the controller 34 may be disposed anywhere on the vehicle 12 or the tank 14, as desired. The controller 34 may include a processor, a non-transitive storage medium for storing a memory of the controller 34, and an instruction set stored to the non-transitive storage medium. The controller 34 is configured to continuously monitor a pressure sensor 35 disposed within the first portion 3 of the tank 14 to expose the pressure sensor 35 to a pressure of the volume of the pressurized air 18. The controller 34 is further configured to provide control signals to the compressor 20 when the pressure sensor 35 detects predetermined conditions within the first portion 3 of the tank 14. For example, the controller 34 may be configured to send a control signal to the compressor 20 for beginning or ceasing operation of the compressor 20 when certain threshold pressure values of the volume of pressurized air 18 are met or exceeded, as explained in greater deal hereinafter with reference to a discussion of a method of operation of the fuel delivery system 10. The controller 34 may be in signal communication with the pressure sensor 35 and the compressor 20 using any known signal connection or electrical connection such as an electrical cable or wire, as desired.

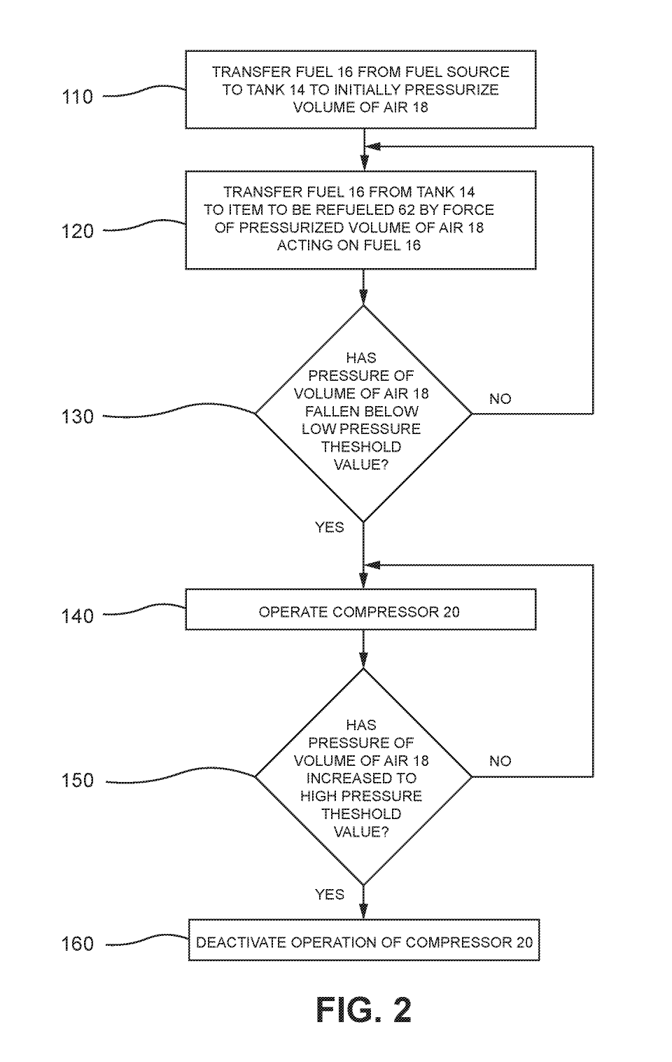

Referring now to FIG. 2, a method of operating the fuel delivery system 10 is described hereafter. The method according to the invention includes a step 110 of transferring the fuel 16 into the tank 14 to initially pressurize the volume of the pressurized air 18. The vehicle 12 is first transported to a source of the fuel 16 such as a fuel tank farm. The initial pressurization of the first portion 3 of the tank 14 having the volume of the pressurized air 18 occurs during a fuel loading of the tank 14 wherein a quantity of the fuel 16 is transferred from fuel loading pumps located at the fuel tank farm to the tank 14 of the fuel delivery system 10. The fuel tank farm provides fuel loading pumps that operate at pressures greater than the maximum desired pressure of the volume of the pressurized air 18 disposed within the tank 14, for example up to three times greater (50 psi), such that during the initial loading of the tank 14 the fuel 16 is able to be pumped through the first fuel connection 46 and the internal tank valve 44 until a desired or maximum tank fuel level is reached within the tank 14. The first and the second overpressure vent devices 36, 38 are configured to relieve the pressure within the first portion 3 of the tank 14 when the pressure within the first portion 3 of the tank 14 exceeds the preselected venting pressure threshold value of the vent devices 36, 38. The venting pressure threshold value may for example be 15 psi. Accordingly, as the fuel 16 is introduced into the tank 14, the volume of the tank 14 occupied by the fuel 16 will increase while the volume of the tank 14 occupied by the air 18 will decrease, thereby pressurizing the volume of the air 18 during the transfer of the fuel 16 into the tank 14.

The pressure of the air 18 is increased until the venting pressure threshold value is surpassed, thereby causing the first and second overpressure vent devices 36, 38 to vent a quantity of the air 18 from the tank 14 to reduce the pressure within the tank 14. Accordingly, the first and second overpressure vent devices 36, 38 may be caused to continuously vent the air 18 from the tank 14 when the level of the fuel 16 within the tank 14 approaches the desired or maximum fuel level. Because the first and second overpressure vent devices 36, 38 are configured to vent the air at a pressure level below the pressure level at which the fuel tank farm supplies the fuel 16, the fuel transfer operation is able to continue despite the decreasing volume and increasing pressure of the pressurized air 18 within the first portion 3 of the tank 14.

Once the tank 14 is adequately filled to initially pressurize the volume of the pressurized air 18, the method according to the invention includes a step 120 of transferring the fuel 16 from the tank 14 to the item to be refueled 62. The vehicle 12 may be driven adjacent the item to be refueled 62 to allow the dead-man fuel nozzle 56 disposed at the end of the flexible fuel transfer hose 48 to reach the refueling port 64. The bonding attachment device 70 is coupled to the item to be refueled 62 and the dead-man fuel nozzle 56 is engaged with the refueling port 64. The manually controlled member 66 may then be adjusted from the first position to the second position to allow the internal tank valve 44 to open in a manner wherein the fuel 16 is caused to flow out of the tank 14 as a result of the force resulting from the pressurization of the air 18 acting on the fuel 16. The actuating device 57 is actuated to open a valve disposed within the dead-man fuel nozzle 56 to allow for the flow of the fuel 16 therethrough. The fuel 16 is then delivered to the item to be refueled so long as the actuating device 57 is actuated and the manually controller member 66 is maintained in the second position by the operator of the fuel delivery system 10. The operator can visually see the at least one fuel meter 54 during the fuel transfer operation, which may register a total volume of the fuel 16 that has been delivered.

According to one embodiment, the connecting line 50, the fuel transfer hose 48, and the dead-man fuel nozzle 56 are sized to provide a fuel delivery rate of approximately 15 to 20 gallons per minute (gpm) of the fuel 16 at a pressure of approximately 10 to 15 psi of the volume of the pressurized air 18. The fuel delivery rate is controlled by the operator while manually positioning the actuating device 57 of the dead-man fuel nozzle 56.

As the fuel 16 is transferred from the tank 14 to the item to be refueled 62, the pressure of the volume of the air 18 will continue to decrease as the volume occupied by the volume of the air 18 continues to increase in response to the exiting of the fuel 16 from the tank 14. Accordingly, to maintain the pressure of the volume of the air 18 within an operating range of the refueling operation, the method according to the invention includes a step 130 of monitoring the pressure of the volume of the air 18 to determine if the pressure of the volume of the air 18 has fallen below a low pressure threshold value. The low pressure threshold value may be a pressure value that is approaching a pressure level insufficient for desirably continuing the removal of the fuel 16 from the tank 14 by use of the volume of the pressurized air 18. The low pressure threshold value accordingly relates to a minimum pressure value of a range of pressures at which the volume of the pressurized air 18 is to be maintained by operation of the controller 34 and the compressor 20 during a fuel transfer operation out of the tank 14. The low pressure threshold value may be 10 psi, for example.

The pressure sensor 35 continuously monitors the pressure of the air 18 within the tank 14 during the transfer of the fuel 16 from the tank 14 to the item to be refueled 62. If the pressure of the air 18 falls below the low pressure threshold value, the pressure sensor 35 communicates this condition to the controller 34. The controller 34 in turn generates a control signal that is sent to the compressor 20 to indicate that the compressor 20 is to begin operation. If the compressor 20 is driven by the belt 26 associated with the engine or motor 2 of the vehicle 12, the control signal may be sent to the clutch assembly 8 of the compressor 20. The clutch assembly 8 may include a clutch plate configured to engage a rotating pulley assembly over which the belt 26 is translated. The clutch plate may be coupled to the rotor of the compressor 20. The clutch plate may be caused to engage the rotating pulley assembly when electrical energy is introduced to the clutch assembly 8 as a result of the receiving of the control signal. If an electric energy source is used to power the compressor 20, the control signal may be sent directly to a power source of the compressor 20 to cause the compressor 20 to begin operation thereof.

Upon the sending of the control signal to the compressor 20, the method according to the invention includes a step 140 of operating the compressor 20 to compress the volume of the air 18 disposed in the tank 20. The compressor 20 draws air in through the inlet side 5 thereof and delivers compressed air at an elevated pressure above the pressure of the ambient environment out of the outlet side 6 thereof. The compressed air is then caused to flow through the first pressure line 22, into the storage tank 24, and through the second pressure line 28. When the pressure of the air flowing through the second pressure line 28 exceeds the pressure within the first portion 3 of the tank 14, the check valve 32 is opened to allow the compressed air to flow into the first portion 3 of the tank 14. The compressor 20 can be continuously or intermittently operated during a fuel transfer process as necessary to maintain the pressure of the volume of the air 18 for a desired fuel flow rate of the fuel 16 out of the tank 14.

The compressor 20 may be sized to deliver a volume of the air at a flow rate determined by the desired flow rate of the fuel 16 out of the tank 14. For example, 4 ft³ of air volume is assumed to be required for each gallon of the fuel 16 delivered at a pressure of 15 psi of the volume of the pressurized air 18. For a fuel delivery rate of 20 gpm, a compressor air flow rate of approximately 80 ft³ per minute is therefore necessary. The anticipated volume of the compressed air storage tank 24 is approximately 10 gallons to provide a buffer volume of compressed air to minimize the number of operation cycles for the compressor 20 during the transfer of the fuel 16 from the tank 14 to the item to be refueled 62.

Once the compressor 20 has been activated in step 140, the method according to the invention includes a step 150 of monitoring the pressure of the air 18 within the first portion 3 of the tank 14 to determine if the pressure of the air 18 has met a preselected high pressure threshold value of the tank 14. During the monitoring step 150, the pressure sensor 35 continuously monitors the pressure of the air 18 as the compressed air is delivered into the first portion 3 of the tank 14 during operation of the compressor 20. If the pressure detected by the pressure sensor 35 meets the high pressure threshold value, the pressure sensor 35 communicates this information to the controller 34. The high pressure threshold value is preferably set to a preselected value substantially similar to the preselected value chosen for the venting pressure threshold value employed by each of the first and second overpressure vent devices 36, 38. However, it may be preferable for the high pressure threshold value to be set to a preselected value slightly lower than the preselected value for the venting pressure threshold value to prevent an incidence wherein the compressor 20 is caused to operate continuously due to the first and second overpressure venting devices 36, 38 starting to vent the pressurized air 18 in advance of the pressure sensor 35 detecting the high pressure threshold value. The difference between the venting pressure threshold and the high pressure threshold may be determined based on a degree of error of the measurements of the pressure sensor 35 or a degree of error relating to the actuating of the first and second overpressure venting devices 36, 38 at the prescribed venting pressure threshold. For example, in some embodiments the venting pressure threshold value and the high pressure threshold value may be within approximately 1 psi of each other, in other embodiments within approximately 0.5 psi of each other, and in yet other embodiments within approximately 0.1 psi of each other, as non-limiting examples. Despite this potential small difference between the venting pressure threshold value and the high pressure threshold value, the venting pressure threshold value and the high pressure threshold value are both referred to herein as being about the same value of 15 psi, as one non-limiting value used for the purposes of the present example.

Upon the determination that the high pressure threshold value has been reached, the method according to the invention includes a step 160 of deactivating or ceasing operation of the compressor 20. The controller 34 sends a control signal to the compressor 20 indicating to the compressor 20 that the compressor 20 should cease operation. For example, if the configuration depicted in FIG. 1 is used, the control signal may be communicated to the clutch assembly 8 to indicate that the clutch plate of the clutch assembly should disengage the rotor of the compressor 20. Alternatively, if the compressor 20 is driven by an electrical source, the control signal may be sent directly to the power source of the compressor 20. The compressor 20 continues operation and continues to pressurize the air 18 disposed within the first portion 3 of the tank 14 until the pressure sensor 35 determines that the high pressure threshold value has been met. If for some reason the pressure sensor 35 were to incorrectly determine the pressure within the first portion 3 of the tank 14, the first and second overpressure vent devices 36, 38 serve as a safety feature for preventing the over-pressurization of the tank 14.

Additionally, the presence of the first and second overpressure vent devices 36, 38 on the tank 14 allows for the compressor 20 to be controlled by the controller 34 in an alternative manner according to another aspect of the invention. For example, instead of monitoring the pressure within the volume of the air 18 to determine if the pressure has met the high pressure threshold value, the controller 34 may be programmed to continue operation of the compressor 20 for a predetermined period of time determined empirically to be suitable for reaching a value substantially equal to the high pressure threshold value as any incidental over-pressurization of the volume of the air 18 beyond the desired high pressure threshold value will be resolved by the venting of a portion of the volume of the air 18 through the first and second overpressure vent devices 36, 38, which in such an instance may be set to have a preselected venting pressure threshold value that is identical to the desired high pressure threshold value.

The pressure sensor 35 continues to monitor the pressure within the first portion 3 of the tank 14 throughout the fuel transfer operation, which may potentially involve multiple subsequent periods of activation and de-activation of the compressor 20 as the pressure of the volume of the air 18 disposed within the tank 14 varies throughout the fuel transfer process. The compressor 20 therefore operates only as necessary as the fuel 16 is removed during a fuel transfer operation or during periods between fuel transfer operations to maintain the pressure of the volume of the pressurized air 18 between the low pressure threshold value and the high pressure threshold value. Once the item to be refueled 62 has been adequately refueled, the operator of the fuel delivery system 10 may disengage all associated fluid couplings and may reposition each manually operated control member to suitably cease the transfer of the fuel 16 from the tank 14 to the item to be refueled 62. The tank 14 is then in a condition to be refueled as described with reference to step 110 according to the method of the invention.

The fuel delivery system 10 accordingly provides numerous benefits over the fuel delivery systems of the prior art including a pump, driveshaft, and associated PTO. First, the compressor 20 offers an efficient and low cost alternative to the more expensive to purchase and more expensive to maintain pump and PTO assembly of the prior art. Second, the component driving the transfer of the fuel, the compressor 20, may be disposed spaced apart from the position of any potential outlet out of the tank 14 while still providing a means to transfer the fuel 16 from the tank 14. In contrast, the pump and PTO arrangement required by the prior art systems generally require the pump to be coupled directly to the drive shaft of the vehicle via the PTO, thereby limiting the freedom of design of the resulting fuel servicing vehicle. Additionally, the transmission of the compressed air from the compressor 20 to either of the storage tank 24 or the tank 14 is able to occur through any type of suitable flow path, such as a pressure line having any shape including multiple linear sections and multiple curved sections weaving through various components disposed within an engine compartment or on a frame of the vehicle 12. This relationship allows the compressed air to be easily routed from one portion of the vehicle 12 to another portion of the vehicle 12 through any available pathway suitable for use with the corresponding packaging arrangement of the vehicle 12. Third, the ability for the volume of the air 18 to be pressurized during the initial transfer of the fuel 16 into the tank 14 improves an efficiency of the system be eliminating initial operation of the compressor 20. Fourth, the method of operating the fuel delivery system 10 further improves an efficiency of the fuel transfer operation by monitoring the pressure within the tank 14 during the fuel transfer operation. The monitoring of the pressure allows for the compressor 20 to only be periodically operated on an as-needed basis, in contrast to the pump and PTO assembly of the prior art, which requires continuous operation of the pump throughout a transfer operation of the fuel.

Example embodiments of the invention are provided so that this disclosure will be thorough, and will fully convey the scope to those who are skilled in the art. Numerous specific details are set forth such as examples of specific components, devices, and methods, to provide a thorough understanding of aspects of the present disclosure. It will be apparent to those skilled in the art that specific details need not be employed, that example aspects may be embodied in many different forms and that neither should be construed to limit the scope of the disclosure. In some example aspects, well-known processes, well-known device structures, and well-known technologies are not described in detail.

The terminology used herein is for the purpose of describing particular example aspects only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed could be termed a second element, component, region, layer or section without departing from the teachings of the example aspects.

The foregoing description of the embodiments of the invention has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fuel delivery system comprising:
a fuel tank including a fuel portion occupied by a volume of a fuel and a pressurized air portion occupied by a volume of pressurized air;
a compressor in fluid communication with the pressurized air portion; and
a controller configured to maintain a pressure of the pressurized air portion between a low pressure threshold value and a high pressure threshold value by selectively operating the compressor.

2. The fuel delivery system of claim 1, wherein the controller is configured to monitor a pressure of the pressurized air portion using a pressure sensor disposed in the pressurized air portion.

3. The fuel delivery system of claim 2, wherein the controller is configured to begin operation of the compressor in response to the pressure sensor sensing that the pressure of the pressurized air portion is below the low pressure threshold value.

4. The fuel delivery system of claim 3, wherein the controller is configured to cease operation of the compressor in response to the pressure sensor sensing that the pressure of the pressurized air portion is at the high pressure threshold value.

5. The fuel delivery system of claim 1, wherein the compressor is disposed in a vehicle carrying the fuel tank, the compressor driven by a motor of the vehicle.

6. The fuel delivery system of claim 5, wherein the controller is in signal communication with a clutch assembly of the compressor engaged with a belt driven by the motor of the vehicle.

7. The fuel delivery system of claim 6, wherein the controller is configured to send a control signal to the clutch assembly to begin operation of the compressor in response to the controller determining that a pressure of the pressurized air portion is below the low pressure threshold value.

8. The fuel delivery system of claim 7, wherein the controller is configured to send a control signal to the clutch assembly to cease operation of the compressor in response to the controller determining that the pressure of the presurized air portion is at the high pressure threshold value.

9. The fuel delivery system of claim 1, wherein the fuel tank includes an overpressure vent device configured to vent a quantity of the air from the compressed air portion in response to a pressure of the air in the pressurized air portion exceeding a venting threshold pressure value.

10. The fuel delivery system of claim 9, wherein the venting pressure threshold value is substantially the same as the high pressure threshold value.

11. The fuel delivery system of claim 9, wherein the venting pressure threshold value is greater than the high pressure threshold value.

12. The fuel delivery system of claim 1, wherein the fuel tank includes a tank valve, an opening of the tank valve causing the fuel to exit the fuel tank through the tank valve under a force of a pressure of the volume of the pressurized air.

13. The fuel delivery system of claim 1, wherein pressurized air exiting the compressor is communicated to the pressurized air portion of the fuel tank by a pressure line having a check valve disposed at an end of the pressure line in the pressurized air portion.

14. A method for transferring a fuel, comprising:
providing a compressor and a fuel tank, the fuel tank having a fuel portion occupied by a volume of the fuel and a pressurized air portion occupied by a volume of pressurized air, the compressor fluidly coupled to the pressurized air portion of the fuel tank;
selectively operating the compressor to maintain a minimum pressure of the pressurized air portion; and
transferring the fuel of the fuel portion to an item to be refueled using only a force of the pressurized air portion acting on the fuel portion.

15. The method of claim 14, wherein the compressor is disposed in a vehicle carrying the fuel tank, the compressor driven by a drive system of the vehicle.

16. The method of claim 15, wherein the step of selectively operating the compressor includes beginning and ceasing a transferring of motion of the drive system of the vehicle to the compressor.

17. The method of claim 14, wherein the step of selectively operating the compressor includes beginning operation of the compressor when a pressure of the pressurized air portion is below a low pressure threshold value.

18. The method of claim 14, wherein the step of selectively operating the compressor includes ceasing operation of the compressor when a pressure of the pressurized air portion is at a high pressure threshold value.

19. The method of claim 14, wherein an initial pressurization of the pressurized air portion of the fuel tank occurs during a transfer of the fuel into the fuel tank.

20. The method of claim 19, wherein the initial pressurization of the pressurized air portion of the fuel tank includes an overpressure venting device venting a quantity of the pressurized air from the fuel tank in response to a pressure of the pressurized air above a venting pressure threshold value.
